(19) United States
(12) Patent Application Publication
(10) Pub. No.: US 2023/0300794 A1
(43) Pub. Date: Sep. 21, 2023

(54) PAGING EXTENSIONS

(71) Applicant: Lenovo (Singapore) Pte. Ltd., New Tech Park (SG)

(72) Inventors: Prateek Basu Mallick, Dreieich (DE); Ravi Kuchibhotla, Chicago, IL (US); Joachim Loehr, Wiesbaden (DE); Genadi Velev, Darmstadt (DE); Hyung-Nam Choi, Ottobrunn (DE)

(21) Appl. No.: 18/020,216

(22) PCT Filed: Aug. 9, 2021
(86) PCT No.: PCT/IB2021/057335

§ 371 Date: Feb. 7, 2023

Related U.S. Application Data
(60) Provisional application No. 63/063,145, filed on Aug. 7, 2020.

(51) Int. Cl. H04W 68/02; H04W 72/23; H04L 1/00; H04W 72/1273

(52) U.S. Cl. CPC H04W 68/02; H04W 72/23; H04L 1/0061; H04W 72/1273

(57) ABSTRACT

Apparatuses, methods, and systems are disclosed for extended paging messages. One User Equipment (“UE”) apparatus in a mobile communication network includes a processor and a transceiver that sends a message to a network node, with the message indicating that the UE apparatus supports paging extensions. The transceiver receives a confirmation message from the network node, with the confirmation message notifying the UE apparatus to expect paging extensions. The transceiver receives paging Downlink Control Information (“DCI”) with a cyclic redundancy check (“CRC”) scrambled by a Paging Radio Network Temporary Identifier (“P-RNTI”), where the paging DCI schedules a Physical Downlink Shared Channel (“PDSCH”) transmission. The transceiver receives a paging message in the PDSCH transmission. The processor identifies a paging extension for the UE in the paging DCI and/or the paging message.

### CROSS-REFERENCE TO RELATED APPLICATIONS

This application claims priority to U.S. Provisional Patent Application No. 63/063,145 entitled “METHODS TO SUPPORT AN EXTENDED PAGING MESSAGE” and filed on Aug. 7, 2020, for Prateek Basu Mallick, Ravi Kuchibhotla, Joachim Loehr, Genadi Velev, and Hyung-Nam Choi, which application is incorporated herein by reference.

### FIELD

The subject matter disclosed herein relates generally to wireless communications and more particularly relates to apparatuses, method, and systems for extended paging messages.

### BACKGROUND

In certain wireless communications systems, a User Equipment (“UE”) device that is not actively sending or receiving data may enter an idle or inactive state to save power. The UE may wake up at specific time instances, for example, once every discontinuous reception (“DRX”) cycle, to monitor for paging messages. Paging messages are provided by means of downlink (“DL”) scheduled Physical Downlink Shared Channel (“PDSCH”) transmissions. Downlink Control Information (“DCI”) schedules the PDSCH transmission, which in turn contains the paging message. However, the information content of both the paging DCI and the paging message is limited.

### BRIEF SUMMARY

Disclosed are procedures for extended paging messages. Said procedures may be implemented by apparatus, systems, methods, or computer program products.

One User Equipment (“UE”) apparatus includes a transceiver that sends a message to a network node, with the message indicating that the UE supports paging extensions. The transceiver receives a confirmation message from the network node, with the confirmation message notifying the UE to expect paging extensions. The transceiver receives paging Downlink Control Information (“DCI”) with a cyclic redundancy check (“CRC”) scrambled by a Paging Radio Network Temporary Identifier (“P-RNTI”), where the paging DCI schedules a Physical Downlink Shared Channel (“PDSCH”) transmission. The transceiver receives a paging message in the PDSCH transmission. The apparatus includes a processor that identifies a paging extension for the UE in the paging DCI and/or the paging message.

One method of a UE device includes sending a message to a network node, the message indicating that the UE device supports paging extensions. The method includes receiving a confirmation message from the network node, the confirmation message notifying the UE device to expect paging extensions. The method includes receiving a paging DCI with a CRC scrambled by a P-RNTI, the paging DCI scheduling a PDSCH transmission. The method includes receiving a paging message in the PDSCH transmission. The method includes identifying a paging extension for the UE device in the paging DCI and/or the paging message.

One network node apparatus includes a transceiver that receives a message from a UE device, with the message indicating that the UE device supports paging extensions. The transceiver sends a confirmation message to the UE device, the confirmation message notifying the UE device to expect paging extensions. The transceiver sends a paging DCI with a CRC scrambled by a P-RNTI, the paging DCI scheduling a PDSCH transmission. The transceiver sends a paging message in the PDSCH transmission. The apparatus includes a processor that includes a paging extension for the UE device in the paging DCI and/or the paging message.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for extended paging messages;

FIG. 2 is a block diagram illustrating one embodiment of a Fifth-Generation (“5G”) New Radio (“NR”) protocol stack;

FIG. 3 is a diagram illustrating one embodiment of a format for a paging message including a paging extension;

FIG. 4 is a diagram illustrating another embodiment of a format for a paging message including a paging extension;

FIG. 5 is a diagram illustrating one embodiment of a table for including a paging extension in the paging DCI;

FIG. 6 is a diagram illustrating another embodiment of a table for including a paging extension in the paging DCI;

FIG. 7 is a diagram illustrating one embodiment of a format for a paging message including an indicator of which UEs receive which paging extensions;

FIG. 8 is a diagram illustrating one embodiment of a format for a paging message including a Boolean flag to notify a UE to monitor for paging extensions;

FIG. 9 is a diagram illustrating one embodiment of a user equipment apparatus that may be used for extended paging messages;

FIG. 10 is a diagram illustrating one embodiment of a network apparatus that may be used for extended paging messages;

FIG. 11 is a flowchart diagram illustrating one embodiment of a first method for extended paging messages; and

FIG. 12 is a flowchart diagram illustrating one embodiment of a second method for extended paging messages.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “at least one of” or “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart diagrams and/or block diagrams.

The flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatuses for extended paging messages. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

To allow for low power consumption, a User Equipment (“UE”) device that is not actively sending or receiving data may enter an idle or inactive state (e.g., RRC_IDLE state or RRC_INACTIVE state), and may wake up at specific time instances, for example, once every discontinuous reception (“DRX”) cycle, to monitor for paging messages. For mobile terminated (“MT”) services in a mobile communication network, where the network has data to transmit to the UE, a paging message may notify the UE that data has arrived, and the UE may act on the paging message by exiting the idle or inactive state and establishing a connection with the network to receive the data.

Paging messages are provided by means of downlink (“DL”) scheduled Physical Downlink Shared Channel (“PDSCH”) transmissions. Downlink Control Information (“DCI”) schedules the PDSCH transmission, which in turn contains the paging message. However, the information content of both the paging DCI and the paging message is limited.

Various DCI formats exist for scheduling downlink and uplink data transmissions by providing the UE with information such as resource allocations (in the frequency domain and the time domain), modulation and coding schemes, and the like. A paging DCI, in various embodiments, may be any existing or new DCI format used to schedule one or more paging messages. For Fifth-Generation (“5G”) New Radio (“NR”), the Release 16 (“Rel-16”) specifications from the Third Generation Partnership Project (“3GPP”) provide that a paging DCI is sent in DCI format 1_0, with a cyclic redundancy check (“CRC”) scrambled by a Paging Radio Network Temporary Identifier (“P-RNTI”). The P-RNTI under Rel-16 is 16 bits long and fixed to decimal value 65534 (hex value 0xFFFE). In some embodiments of the current disclosure, however, another P-RNTI may be used, as described below.

A UE that periodically monitors for DCI format 1_0, and successfully decodes the DCI format 1_0 using the P-RNTI, may use the frequency and time resources allocated in the paging DCI to receive a PDSCH transmission scheduled by the DCI, and may demodulate and decode the PDSCH transmission to extract the paging message(s). The paging DCI in format 1_0 with CRC scrambled by P-RNTI may be received by multiple UEs, and the corresponding PDSCH transmission may include paging information for multiple UEs (e.g., multiple paging messages, or multiple paging records within a paging message), within the same paging transmission.

Under the Rel-16 specifications, the information content of paging DCI (e.g., DCI format 1_0 with CRC scrambled by P-RNTI) and a paging message (e.g., a Radio Resource Control (“RRC”) paging message in the PDSCH transmission) are limited. It may be desirable to include additional information in the paging DCI or the paging message (collectively, the paging information) for a number of reasons. For example, it may be useful to include a “multiple SIM” (“MUSIM”) paging cause in the paging information sent to a UE using multiple subscriber identification modules (“SIMs”). Similarly, for mobile terminated services where the network has data to transmit to the UE, it may be useful for the paging information to include the type of MT initiating service, the identifier of the MT service, or the Application ID of the MT service. To support network slicing, it may be useful for the paging information to include Single-Network Slice Selection Assistance Information (“S-NSSAI”) that uniquely identifies a network slice. It may also be useful to send paging information with certain conditions, so that the UE responds to the page when one or more of these conditions are fulfilled.

In various of these cases, sending additional information to the UE in the paging DCI or the paging message may reduce latency for this information by providing it directly to the UE without waiting for the UE to respond to the page and establish a connection for receiving the information. In some cases, the additional information in paging DCI or the paging message may facilitate the UE responding to the page. For example, in a situation with multiple SIMs in one UE or multiple network slices, paging information that defines which SIM or network slice the UE should use may facilitate the UE acting on the page to establish a connection. Similarly, paging information that defines conditions for responding to the page may allow the UE to save power by responding only when the conditions are met rather than responding immediately.

This additional information included in the paging DCI and/or the paging message is referred to as a paging extension (“PE”). More generally, information included in a paging DCI and/or a paging message may be referred to as a paging extension if this information is not specified for inclusion in the paging message in the 3GPP Rel-16 specifications or previous 3GPP specifications. Thus, even if future 3GPP specifications provide for inclusion of such information in a paging DCI and/or a paging message, the information not specified in Rel-16 for inclusion in the paging information may still be referred to herein as a “paging extension.”

Conversely, the term “legacy” may be used herein with reference to paging implementations specified by Rel-16 or previous 3GPP specifications. Thus Rel-16 may be said to define a legacy paging DCI, using a legacy DCI format (e.g., DCI format 1_0), with CRC scrambled by a legacy P-RNTI (e.g., 0xFFFE), for scheduling a legacy PDSCH transmission, in which a legacy paging message is sent for paging UE devices without paging extensions.

However, the limited information content specified in Rel-16 for paging DCI and RRC paging messages limits the ability to extend the paging message (or paging DCI) to include additional information such as paging extensions. For example, in 3GPP technical specification (“TS”) 38.212, a paging DCI using DCI format 1_0 with CRC scrambled by P-RNTI includes a two-bit Short Message Indicator field, an eight-bit Short Message field, a variable-width Frequency domain resource assignment field, a four-bit Time domain resource assignment field, a one-bit VRB-to-PRB mapping field, a five-bit Modulation and coding scheme field, a two-bit TB scaling field, and a six-bit Reserved Bits field. The bit field for the Short Message Indicator has binary value “01” if only scheduling information for paging is present in the DCI, binary value “10” if only a short message is present in the DCI, and binary value “11” if both scheduling information for paging and a short message are present in the DCI. (The binary value “00” is reserved.)

Thus, the paging DCI includes a small number of bits, most of which are used to schedule the paging transmission. If the DCI includes scheduling information for paging without a short message, only the eight bits in the Short Message field and the six bits in the Reserved Bits field are available. If the DCI also includes a short message, only the six bits in the Reserved bits field are available.

The information content specified in Rel-16 for an RRC paging message is similarly limited. For example, 3GPP TS 38.331 provides that a PagingRecordList in an RRC paging message is a sequence of one to maxNrofPageRec (i.e., thirty-two) PagingRecords, and that a PagingRecord includes a ue-Identity for the UE being paged, with an optional accessType. Further fields of the paging record are not defined. Thus, although a paging message in a PDSCH transmission may page up to thirty-two different UEs (identified in a sequence of up to thirty-two PagingRecords), the individual paging records do not do much more than identify which UEs are being paged, possibly with which accessTypes. No fields are defined for information such as a MUSIM paging cause, an S-NSSAI for a network slice, or a condition to meet before responding on the page.

The present disclosure addresses how to enhance a paging DCI and/or a paging message to provide a paging extension. In various embodiments, as described below, providing a paging extension may involve increasing the size of the paging message (relative to a legacy paging message), encoding information into the limited number of reserved bits in the paging DCI, and/or providing the paging extension in a PDSCH transmission separate from a legacy PDSCH transmission used for paging UE devices without paging extensions.

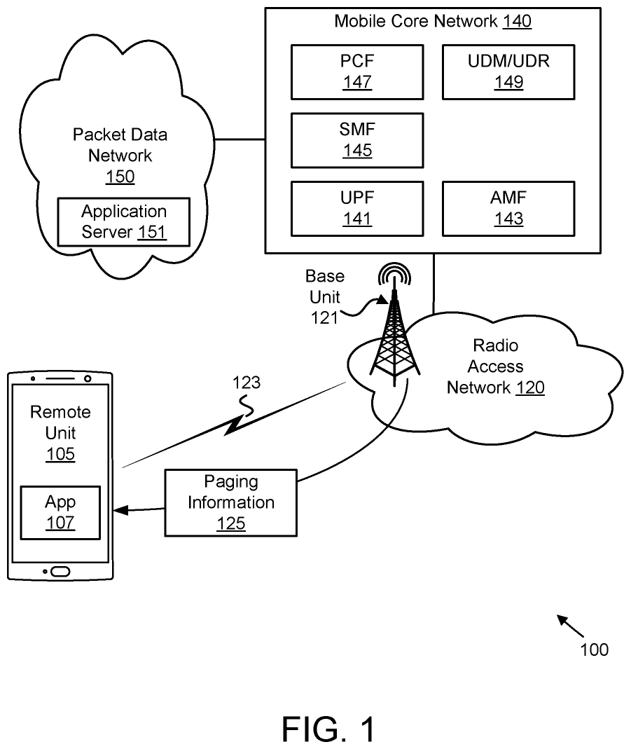

FIG. 1 depicts a wireless communication system 100 for extended paging messages, according to embodiments of the disclosure. In one embodiment, the wireless communication system 100 includes at least one remote unit 105, a radio access network (“RAN”) 120, and a mobile core network 140. The RAN 120 and the mobile core network 140 form a mobile communication network. The RAN 120 may be composed of a base unit 121 with which the remote unit 105 communicates using wireless communication links 123. Even though a specific number of remote units 105, base units 121, wireless communication links 123, RANs 120, and mobile core networks 140 are depicted in FIG. 1, one of skill in the art will recognize that any number of remote units 105, base units 121, wireless communication links 123, RANs 120, and mobile core networks 140 may be included in the wireless communication system 100.

In one implementation, the RAN 120 is compliant with the 5G system specified in the Third Generation Partnership Project (“3GPP”) specifications. For example, the RAN 120 may be a Next Generation Radio Access Network (“NG-RAN”), implementing New Radio (“NR”) Radio Access Technology (“RAT”) and/or Long-Term Evolution (“LTE”) RAT. In another example, the RAN 120 may include non-3GPP RAT (e.g., Wi-Fi® or Institute of Electrical and Electronics Engineers (“IEEE”) 802.11-family compliant WLAN). In another implementation, the RAN 120 is compliant with the LTE system specified in the 3GPP specifications. More generally, however, the wireless communication system 100 may implement some other open or proprietary communication network, for example Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

The remote units 105 may communicate directly with one or more of the base units 121 in the RAN 120 via uplink (“UL”) and downlink (“DL”) communication signals. Furthermore, the UL and DL communication signals may be carried over the wireless communication links 123. Here, the RAN 120 is an intermediate network that provides the remote units 105 with access to the mobile core network 140. As described in greater detail below, a base unit 121 and a remote unit 105 may communicate for paging, with paging extensions. A base unit 121 for a RAN 120 may send paging information 125, such as a paging DCI to schedule a PDSCH transmission and a paging message in the PDSCH transmission, to the remote unit 105. The paging information 125 may include a paging extension.

In some embodiments, a handshake between a base unit 121 and a remote unit 105 may establish whether the remote unit 105 should expect paging with paging extensions, or whether legacy paging (without paging extensions) will be used. For example, a remote unit 105 may send a message to the base unit 121 indicating that the remote unit 105 supports paging extensions. In response, if the base unit 121 also supports paging extensions, and is configured to send paging extensions to the remote unit 105, the base unit 121 may send a confirmation message to the remote unit 105, notifying the remote unit 105 to expect paging extensions. Optionally, this handshake may be initiated by the base unit 121 advertising or broadcasting that it supports paging extensions, prior to the remote unit 105 sending the message that it also supports paging extensions, and the base unit 121 confirming that paging extensions will be used.

In further embodiments, the base unit 121 may page the remote unit 105 by sending a paging DCI with CRC scrambled by P-RNTI, to schedule a PDSCH transmission, and sending a paging message in the PDSCH transmission. The base unit 121 may include a paging extension in the paging DCI and/or the paging message. The remote unit 105 may receive the paging DCI and the paging message, and identify a paging extension in the paging DCI and/or the paging message.

In some embodiments, the handshake to determine whether paging will include paging extensions may occur at a separate time from the actual paging with the paging extension. For example, the handshake may occur during initial registration of the remote unit 105 to connect to the mobile core network 140, and the paging information 125 may be transmitted at a later time. Handshake information to establish support for paging extensions, and paging information 125 including paging extensions, may be transmitted and received between the remote unit 105 and the base unit 121, with the base unit 121 transmitting and receiving information for the RAN 120 and/or for the mobile core network 140. For example, handshake information may be exchanged between the remote unit 105 and the RAN 120 using RRC procedures, or may be exchanged between the remote unit 105 and the Access and Mobility Management Function (“AMF”) 143 in the mobile core network 140 using Non-Access Stratum (“NAS”) registration procedures. In either case, a base unit 121 exchanges the relevant information with the remote unit 105.

In some embodiments, the remote units 105 communicate with an application server 151 via a network connection with the mobile core network 140. For example, an application 107 (e.g., web browser, media client, telephone and/or Voice-over-Internet-Protocol (“VoIP”) application) in a remote unit 105 may trigger the remote unit 105 to establish a protocol data unit (“PDU”) session (or other data connection) with the mobile core network 140 via the RAN 120. The mobile core network 140 then relays traffic between the remote unit 105 and the application server 151 in the packet data network 150 using the PDU session. The PDU session represents a logical connection between the remote unit 105 and the User Plane Function (“UPF”) 141.

In order to establish the PDU session (or PDN connection), the remote unit 105 must be registered with the mobile core network 140 (also referred to as “attached to the mobile core network” in the context of a Fourth Generation (“4G”) system). Note that the remote unit 105 may establish one or more PDU sessions (or other data connections) with the mobile core network 140. As such, the remote unit 105 may have at least one PDU session for communicating with the packet data network 150. The remote unit 105 may establish additional PDU sessions for communicating with other data networks and/or other communication peers.

In the context of a 5G system (“5GS”), the term “PDU Session” refers to a data connection that provides end-to-end (“E2E”) user plane (“UP”) connectivity between the remote unit 105 and a specific Data Network (“DN”) through the UPF 141. A PDU Session supports one or more Quality of Service (“QoS”) Flows. In certain embodiments, there may be a one-to-one mapping between a QoS Flow and a QoS profile, such that all packets belonging to a specific QoS Flow have the same 5G QoS Identifier (“5QI”).

In the context of a 4G/LTE system, such as the Evolved Packet System (“EPS”), a Packet Data Network (“PDN”) connection (also referred to as EPS session) provides E2E UP connectivity between the remote unit and a PDN. The PDN connectivity procedure establishes an EPS Bearer, i.e., a tunnel between the remote unit 105 and a Packet Gateway (“PGW”, not shown) in the mobile core network 140. In certain embodiments, there is a one-to-one mapping between an EPS Bearer and a QoS profile, such that all packets belonging to a specific EPS Bearer have the same QoS Class Identifier (“QCI”).

The base units 121 may be distributed over a geographic region. In certain embodiments, a base unit 121 may also be referred to as an access terminal, an access point, a base, a base station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a relay node, a RAN node, or by any other terminology used in the art. The base units 121 are generally part of a RAN, such as the RAN 120, that may include one or more controllers communicably coupled to one or more corresponding base units 121. These and other elements of radio access network are not illustrated but are well known generally by those having ordinary skill in the art. The base units 121 connect to the mobile core network 140 via the RAN 120.

The base units 121 may serve a number of remote units 105 within a serving area, for example, a cell or a cell sector, via a wireless communication link 123. The base units 121 may communicate directly with one or more of the remote units 105 via communication signals. Generally, the base units 121 transmit DL communication signals to serve the remote units 105 in the time, frequency, and/or spatial domain. Furthermore, the DL communication signals may be carried over the wireless communication links 123. The wireless communication links 123 may be any suitable carrier in licensed or unlicensed radio spectrum. The wireless communication links 123 facilitate communication between one or more of the remote units 105 and/or one or more of the base units 121. Note that during NR operation on unlicensed spectrum (referred to as “NR-U”), the base unit 121 and the remote unit 105 communicate over unlicensed (i.e., shared) radio spectrum.

In one embodiment, the mobile core network 140 is a 5G core network (“5GC”) or an Evolved Packet Core (“EPC”), which may be coupled to a packet data network 150, like the Internet and private data networks, among other data networks. A remote unit 105 may have a subscription or other account with the mobile core network 140. In various embodiments, each mobile core network 140 belongs to a single mobile network operator (“MNO”). The present disclosure is not intended to be limited to the implementation of any particular wireless communication system architecture or protocol.

The mobile core network 140 includes several network functions (“NFs”). As depicted, the mobile core network 140 includes at least one UPF 141. The mobile core network 140 also includes multiple control plane (“CP”) functions including, but not limited to, an Access and Mobility Management Function (“AMF”) 143 that serves the RAN 120, a Session Management Function (“SMF”) 145, a Policy Control Function (“PCF”) 147, a Unified Data Management function (“UDM”) and a User Data Repository (“UDR”). Although specific numbers and types of network functions are depicted in FIG. 1, one of skill in the art will recognize that any number and type of network functions may be included in the mobile core network 140.

The UPF(s) 141 is/are responsible for packet routing and forwarding, packet inspection, QoS handling, and external PDU session for interconnecting Data Network (“DN”), in the 5G architecture. The AMF 143 is responsible for termination of NAS signaling, NAS ciphering & integrity protection, registration management, connection management, mobility management, access authentication and authorization, security context management. The SMF 145 is responsible for session management (i.e., session establishment, modification, release), remote unit (i.e., UE) IP address allocation & management, DL data notification, and traffic steering configuration of the UPF 141 for proper traffic routing.

The PCF 147 is responsible for unified policy framework, providing policy rules to CP functions, access subscription information for policy decisions in UDR. The UDM is responsible for generation of Authentication and Key Agreement (“AKA”) credentials, user identification handling, access authorization, subscription management. The UDR is a repository of subscriber information and may be used to service a number of network functions. For example, the UDR may store subscription data, policy-related data, subscriber-related data that is permitted to be exposed to third party applications, and the like. In some embodiments, the UDM is co-located with the UDR, depicted as combined entity “UDM/UDR” 149.

In various embodiments, the mobile core network 140 may also include a Network Repository Function (“NRF”) (which provides Network Function (“NF”) service registration and discovery, enabling NFs to identify appropriate services in one another and communicate with each other over Application Programming Interfaces (“APIs”)), a Network Exposure Function (“NEF”) (which is responsible for making network data and resources easily accessible to customers and network partners), an Authentication Server Function (“AUSF”), or other NFs defined for the 5GC. When present, the AUSF may act as an authentication server and/or authentication proxy, thereby allowing the AMF 143 to authenticate a remote unit 105. In certain embodiments, the mobile core network 140 may include an authentication, authorization, and accounting (“AAA”) server.

In various embodiments, the mobile core network 140 supports different types of mobile data connections and different types of network slices, wherein each mobile data connection utilizes a specific network slice. Here, a “network slice” refers to a portion of the mobile core network 140 optimized for a certain traffic type or communication service. For example, one or more network slices may be optimized for enhanced mobile broadband (“eMBB”) service. As another example, one or more network slices may be optimized for ultra-reliable low-latency communication (“URLLC”) service. In other examples, a network slice may be optimized for machine type communication (“MTC”) service, massive MTC (“mMTC”) service, Internet-of-Things (“IoT”) service. In yet other examples, a network slice may be deployed for a specific application service, a vertical service, a specific use case, etc.

A network slice instance may be identified by a single-network slice selection assistance information (“S-NSSAI”) while a set of network slices for which the remote unit 105 is authorized to use is identified by network slice selection assistance information (“NSSAI”). Here, “NSSAI” refers to a vector value including one or more S-NSSAI values. In certain embodiments, the various network slices may include separate instances of network functions, such as the SMF 145 and UPF 141. In some embodiments, the different network slices may share some common network functions, such as the AMF 143. The different network slices are not shown in FIG. 1 for ease of illustration, but their support is assumed.

While FIG. 1 depicts components of a 5G RAN and a 5G core network, the described embodiments for extended paging messages apply to other types of communication networks and RATs, including IEEE 802.11 variants, Global System for Mobile Communications (“GSM”, i.e., a 2G digital cellular network), General Packet Radio Service (“GPRS”), Universal Mobile Telecommunications System (“UMTS”), LTE variants, CDMA 2000, Bluetooth, ZigBee, Sigfox, and the like.

Moreover, in an LTE variant where the mobile core network 140 is an EPC, the depicted network functions may be replaced with appropriate EPC entities, such as a Mobility Management Entity (“MME”), a Serving Gateway (“SGW”), a PGW, a Home Subscriber Server (“HSS”), and the like. For example, the AMF 143 may be mapped to an MME, the SMF 145 may be mapped to a control plane portion of a PGW and/or to an MME, the UPF 141 may be mapped to an SGW and a user plane portion of the PGW, the UDM/UDR 149 may be mapped to an HSS, etc.

In the following descriptions, the term “RAN node” is used for the base station but it is replaceable by any other radio access node, e.g., gNB, eNB, Base Station (“BS”), Access Point (“AP”), etc. Further, the operations are described mainly in the context of 5G NR. However, the proposed solutions/methods are also equally applicable to other mobile communication systems supporting extended paging messages.

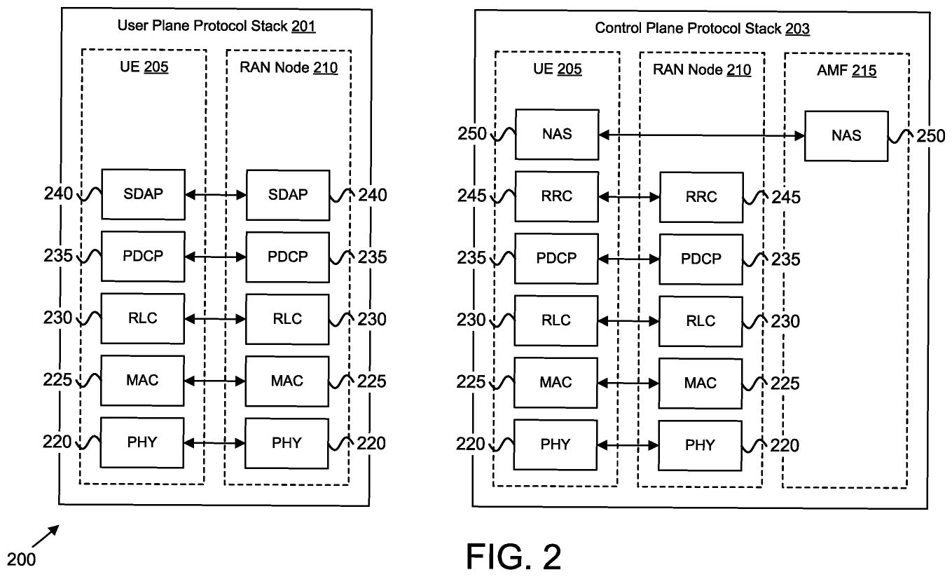

FIG. 2 depicts a NR protocol stack 200, according to embodiments of the disclosure. While FIG. 2 shows the UE 205, the RAN node 210 and an AMF 215 in a 5G core network (“5GC”), these are representative of a set of remote units 105 interacting with a base unit 121 and a mobile core network 140. As depicted, the protocol stack 200 comprises a User Plane protocol stack 201 and a Control Plane protocol stack 203. The User Plane protocol stack 201 includes a physical (“PHY”) layer 220, a Medium Access Control (“MAC”) sublayer 225, the Radio Link Control (“RLC”) sublayer 230, a Packet Data Convergence Protocol (“PDCP”) sublayer 235, and Service Data Adaptation Protocol (“SDAP”) layer 240. The Control Plane protocol stack 203 includes a physical layer 220, a MAC sublayer 225, a RLC sublayer 230, and a PDCP sublayer 235. The Control Plane protocol stack 203 also includes a Radio Resource Control (“RRC”) layer 245 and a Non-Access Stratum (“NAS”) layer 250.

The AS layer (also referred to as “AS protocol stack”) for the User Plane protocol stack 201 consists of at least SDAP, PDCP, RLC and MAC sublayers, and the physical layer. The AS layer for the Control Plane protocol stack 203 consists of at least RRC, PDCP, RLC and MAC sublayers, and the physical layer. The Layer-2 (“L2”) is split into the SDAP, PDCP, RLC and MAC sublayers. The Layer-3 (“L3”) includes the RRC sublayer 245 and the NAS layer 250 for the control plane and includes, e.g., an Internet Protocol (“IP”) layer and/or PDU Layer (not depicted) for the user plane. L1 and L2 are referred to as “lower layers,” while L3 and above (e.g., transport layer, application layer) are referred to as “higher layers” or “upper layers.”

The physical layer 220 offers transport channels to the MAC sublayer 225. The physical layer 220 may perform a Clear Channel Assessment and/or Listen-Before-Talk (“CCA/LBT”) procedure using energy detection thresholds, as described herein. In certain embodiments, the physical layer 220 may send a notification of UL Listen-Before-Talk (“LBT”) failure to a MAC entity at the MAC sublayer 225. The MAC sublayer 225 offers logical channels to the RLC sublayer 230. The RLC sublayer 230 offers RLC channels to the PDCP sublayer 235. The PDCP sublayer 235 offers radio bearers to the SDAP sublayer 240 and/or RRC layer 245. The SDAP sublayer 240 offers QoS flows to the core network (e.g., 5GC). The RRC layer 245 provides for the addition, modification, and release of Carrier Aggregation and/or Dual Connectivity. The RRC layer 245 also manages the establishment, configuration, maintenance, and release of Signaling Radio Bearers (“SRBs”) and Data Radio Bearers (“DRBs”).

The NAS layer 250 is between the UE 205 and the 5GC 215. NAS messages are passed transparently through the RAN. The NAS layer 250 is used to manage the establishment of communication sessions and for maintaining continuous communications with the UE 205 as it moves between different cells of the RAN. In contrast, the AS layer is between the UE 205 and the RAN (i.e., RAN node 210) and carries information over the wireless portion of the network.

As described above, in NR Release 16, the information content for paging DCIs and RRC paging messages is specified and limited. The paging DCI includes a small number of bits, most of which are used to schedule the paging transmission. If the DCI includes scheduling information for paging without a short message, only the eight bits in the Short Message field and the six bits in the Reserved Bits field are available. If the DCI also includes a short message, only the six bits in the Reserved bits field are available. The paging message includes up to thirty-two paging records that mainly identify which UEs are being paged, without defining fields for a paging extension.

As described herein, various solutions for providing paging extensions are possible using the limited space available inside the paging DCI or the RRC paging message. Additionally, solutions are discussed for use in cases where this space in the paging DCI or the RRC paging message is unavailable, or insufficient for the information in the paging extension(s).

In various embodiments, the proposed solutions may facilitate the UE responding to a paging message, by defining information such as which SIM a UE (e.g., UE 205) with multiple SIMs should use for responding to a paging message, an S-NSSAI identifying which network slice to use to act on the paging message, conditions that should be met prior to acting on the paging message, or the like. In some embodiments, the proposed solutions may reduce latency for the information in the paging extension by providing this information directly to the UE before the UE responds to the paging message.

In some embodiments of the proposed solutions, new UEs (e.g., UEs that implement or conform to 3GPP release 17, 18 or subsequent specifications) are capable of interpreting the paging extensions defined and may have been configured by the network to “expect” such paging extensions. However, legacy UEs (e.g., UEs that implement or conform to 3GPP release 16, 15 or previous specifications), may not be capable of interpreting or acting on paging extensions (“PEs”). To this end, handshake procedures may allow UEs that support paging extensions and networks that support paging extensions to establish whether paging extensions will be used.

A UE 205 capable of receiving and acting on a paging extension may signal this capability to the network by sending a message to a network node (e.g., the AMF 215 or a RAN node 210), with the message indicating that the UE supports paging extensions. This capability may be signaled within a Registration Request message sent to the AMF 215. The network node may receive this message and send a confirmation message to the UE 205, where the confirmation message notifies the UE 205 to expect paging extensions. A UE 205 that receives this confirmation message may therefore expect paging extensions. This handshake may occur during initial attach/registration of the UE 205 with the network or at another time prior to paging. Paging DCI may be sent at a later time, such as a paging occurrence during a DRX cycle.

Optionally, this handshake may be initiated by (or may occur in response to) the network node advertising (broadcasting) that it supports this feature. The network node (e.g., the AMF 215 or a RAN node 210) may send a message indicating network support for paging extensions. Such a message may be sent using Broadcast, or dedicated RRC or NAS signaling messages. The UE 205 may receive this message, so that the UE 205 sending (and the network node receiving) the message to indicate that the UE 205 supports PEs is in response to the network first indicating that it supports this capability. In another embodiment, the message to indicate that the UE supports PEs may be sent blindly. In either case, a confirmation message from the network node may still be sent to notify the UE device to expect paging extensions.

A PE handshake between the UE 205 and the AMF 215 (or MME for E-UTRA) can be achieved using NAS registration, Service request procedures. For a NAS handshake between the UE 205 and AMF 215, the confirmation may occur in a NAS response message, such as Registration Accept.

A handshake between the UE 205 and its serving RAN node 210 (e.g., gNB for NR, or eNB for E-UTRA) can be achieved using existing RRC procedure including UECapabilityEnquiry, UE Assistance Information, RRC reconfiguration and/or RRCRelease procedures and messages. The RAN-based handshaking is useful for RAN-based paging (e.g., for SI updates and/or RAN Paging for UEs in the RRC Inactive state). For the RAN/RRC handshake, confirmation may occur in in a RRC message from the RAN node 210.

If the UE 205 does not send a message indicating that it supports paging extensions (e.g., if the UE is a legacy UE), or if the network node (e.g., the AMF 215 or a RAN node 210) does not notify the UE 205 to expect paging extensions (e.g., if the network node is a legacy network node, or if the network is configured not to send paging extensions to that particular UE), then paging extensions will not be sent or received between the network node and that UE 205.

In either case, paging may later occur by means of DL scheduled PDSCH transmissions. In order to allow for low power consumption, a UE 205 is only supposed to wake up at specific time instances, for example, once every DRX Cycle, to monitor for paging messages. The network node may send paging DCI with CRC scrambled by P-RNTI to schedule a PDSCH transmission, and may send a paging message in the PDSCH transmission. The UE 205 may receive the paging DCI and the paging message in the PDSCH transmission. For example, the UE 205 may demodulate and decode the PDSCH transmission scheduled by the paging DCI, to extract the paging message(s). There may be multiple paging messages, corresponding to different UEs 205, within the same paging transmission, or multiple paging records corresponding to different UEs 205 within the same paging message.

If the handshake is not successful, a UE 205 may not support PEs or may support PEs but not expect them from the network, in which case legacy paging may be used. However, if this handshake is successful so that the network knows the UE 205 supports PEs and the UE 205 knows to expect PEs from the network, then the network node may include a paging extension for the UE 205 in the paging DCI and/or the paging message. Thus, the UE 205 may identify a paging extension for the UE 205 in the paging DCI and/or the paging message. For example, if the paging message (possibly for multiple UEs) includes a PagingRecord with the ue-Identity present for that UE 205, and if a paging extension for the UE 205 is present in the paging information, then the UE 205 may interpret and act on that paging extension.

With a handshake performed so that the network knows the UE 205 supports PEs and the UE 205 knows to expect PEs from the network, various solutions are discussed herein for providing the paging extensions. According to a first solution of the disclosure, providing a paging extension includes increasing the size of the paging message (relative to a legacy paging message). According to a second solution of the disclosure, providing a paging extension includes encoding information into the limited number of reserved bits in the paging DCI. According to a third solution of the disclosure, providing a paging extension includes providing the paging extension in a PDSCH transmission separate from a legacy PDSCH transmission used for paging UE devices without paging extensions.

According to embodiments of a first solution, providing a paging extension includes increasing the size of the paging message (relative to a legacy paging message). In some embodiments, the paging message in the PDSCH transmission is an RRC paging message, and the paging extension is included in the RRC paging message. The size of the RRC paging message is increased (relative to a comparable legacy paging message), to accommodate the paging extension.

To include new content in the RRC Paging message itself, the case paging DCI format 1_0 with CRC scrambled by P-RNTI may signal a higher frequency and/or time domain resource assignment than for a legacy paging message. Resource assignment may also be affected by how many PagingRecords are included in the Paging message. Since legacy paging messages support up to thirty-two PagingRecords, a paging message that includes a smaller number of PagingRecords may be able to include PEs for one or a few PagingRecords without using more frequency or time resources than a legacy paging message.

New content (e.g., a paging extension) in in the RRC Paging message can be included using any of the techniques allowed by the Abstract Syntax Notation One (“ASN.1”) interface description language used to define the contents of the RRC paging message. New information elements (“IEs”) may be specified for an RRC Paging message using ASN.1 extension markers (‘ . . . ’), nonCriticalExtension or CriticalExtension.

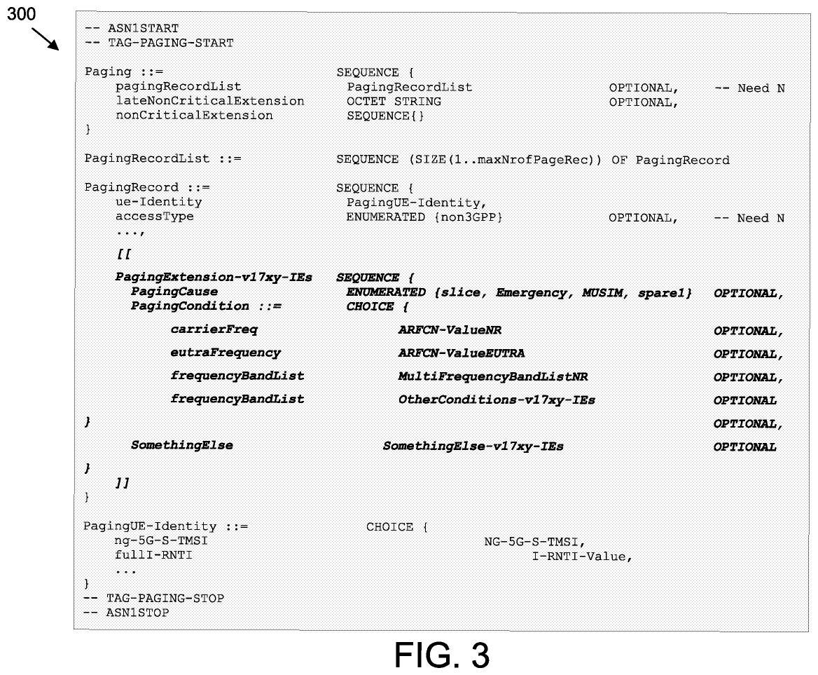

FIG. 3 is a diagram illustrating one embodiment of a format 300 for a paging message, including a paging extension specified using ASN.1 extension markers (‘ . . . ’). Bold plus italic typeface is used to show modifications to the legacy RRC paging message specification, to support PEs. In the depicted paging message format 300, the PagingRecord that specifies the identity of the UE being paged is modified to include a new information element, PagingExtension-v17xy-IEs. By using ASN.1 extension markers (‘ . . . ’), PagingExtension-v17xy-IEs is added in a backward compatible way not affecting the legacy UEs. The example in FIG. 3 including the PagingExtension-v17xy-IEs in the PagingRecord is one such container with extra information that can be signaled. The fields included such as Paging cause are exemplary fields and need not all be present in a container. Different combinations of fields in the container may be adopted for implementation.

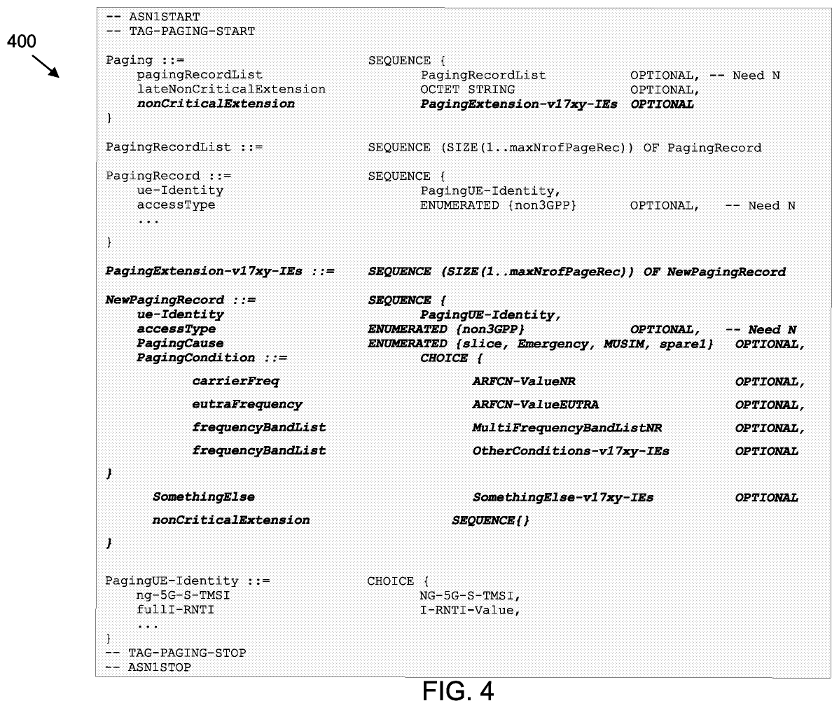

FIG. 4 is a diagram illustrating another embodiment of a format 400 for a paging message, including a paging extension specified using an ASN.1 nonCriticalExtension. As in FIG. 3, bold plus italic typeface is used to show modifications to the legacy RRC paging message specification, to support PEs. In the depicted paging message format 400, the legacy PagingRecordList of PagingRecords is still defined for compatibility with legacy UEs, or for paging without PEs, and PagingExtension-v17xy-IEs is defined as a nonCriticalExtension, comprising a sequence of NewPagingRecord containers, where the NewPagingRecord containers include the ue-Identities for the UEs being paged with paging extensions, and the paging extension information.

According to embodiments of a second solution, providing a paging extension includes encoding information into the limited number of reserved bits in the paging DCI. In some embodiments, because a limited number of bits are available in the paging DCI, a table may be used to convert one or more information elements to an integer that can be sent and received in the paging DCI. Information that a table maps to integers may include PagingExtension-v17xy-IEs, NewPagingRecord containers, a PagingCause, a PagingCondition, as described above and depicted in FIGS. 3 and 4, as well as other information elements, or combinations of information elements. Thus, where the PE is an integer, the network node may determine the integer based on a table that maps integers to information elements, and the UE may reference a table to convert the integer back to at least one information element. The network node and the UE may be provided with the same table to map integers to PE information elements, so that the information in the PE can be transferred by sending and receiving the integer.

In some embodiments of the second solution, to signal a Paging Extension (PE), the PE is put directly in the Paging DCI format 1_0 with CRC scrambled by P-RNTI. In this DCI format at least 6 bits are available already in a six-bit “Reserved Bits” field in Rel-16. In addition to this, when the DCI does not include a short message, the eight-bit “Short Messages” field becomes available. Even when “Short Messages” is actually used, the message may be less than eight bits and the remaining bits of the Short Messages field may be used for a PE. As such, fourteen bits are assigned to an eight-bit Short Messages field and a six-bit Reserved Bits field are potentially available in the paging DCI, where at least six bits and up to fourteen bits may be actually available depending on whether a short message is present. The paging extension may be an integer included in the paging DCI, within these six to fourteen bits. Some of these bits can be coded in a variety of ways to carry up to 2\hat{ }14 (i.e., more than 16 k possibilities) rows of information—where each row means some combination of desired PE characteristics like PagingCause, PagingCondition etc.

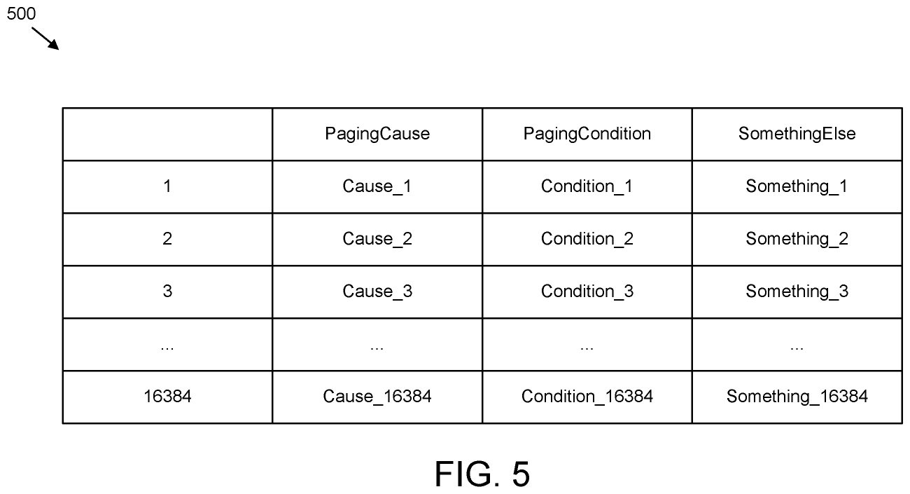

FIG. 5 depicts one example of a table 500 showing the possibility of including PE directly in the Paging DCI. The table 500 shows an implementation of how the 14 bits can be used to convey a single PE. Of course, one may not need so many combinations and therefore some of the 14 bits may not be used. Also, not all elements of a column need to be unique. For example, Cause_1 can be the same as Cause_3 etc. The UE and the network node may reference such a table 500 to convert information elements to integers, transfer an integer paging extension in the paging DCI, and convert the integer paging extension back to information elements. However, one drawback of this method is that if the fourteen bits of the paging DCI encode one integer, only one PE is signaled at a time to all the UEs included in this instance of the legacy

Paging Message.

If the different UEs that support the Paging extension feature are to be signaled with different paging extensions, such an implementation would not work. To mitigate this, the fourteen bits potentially available in the paging DCI may be partitioned to signal multiple integers as paging extensions to multiple UE devices. For example, the available fourteen bits can be partitioned in to two groups of seven bits each, or even seven groups of two bits each, or even fourteen groups of one bit each. The number of groups the bits are partitioned into would equal the number of distinct UEs that can be signaled with distinct paging extensions.

There is a trade-off between how many combinations can be signaled and how many different combinations are useful. As an example, a paging DCI may include 2 PEs of 7 bits each, where PE_index0 refers to first (most/least significant) 7 bits and PE_index1 refers to last (most/least significant) 7 bits. The number of PEs and their bit-length are merely examples and in practice, some bits may still be kept (reserved) for future use, with appropriate changes to the DCI signaling format, and not used for PEs.

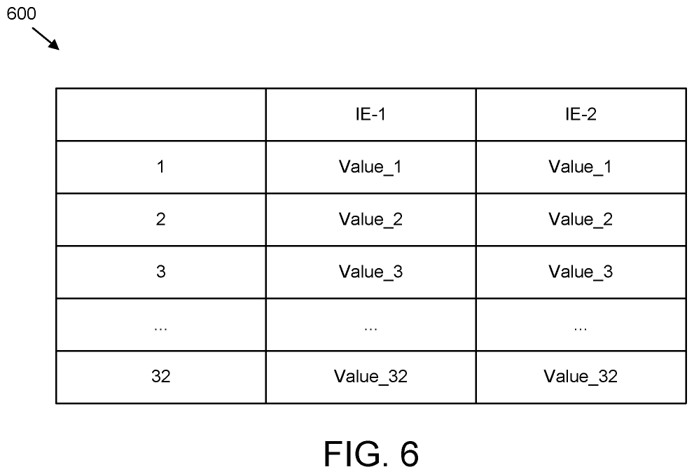

FIG. 6 depicts another example of a table 600 for including a paging extension as an integer in the paging DCI. As with table 500, a network node and a UE may reference such a table 600 to convert between an integer paging extension and the information elements for the paging extension, and may transmit the integer in the paging DCI without transmitting the table in the paging DCI. In this example, the table 600 includes information element (“IE”) dependence. Such a table 600 may be constructed where the presence of an IE-2 (column-2) is dependent on the value of another IE-1 (column-1). Even the length of IE-2, when present, could depend on the value of IE-1. The IE-2 could be even a bit-string that can be passed on by RRC to upper layers. In the table 600, an example of the same is shown where the number of such combinations (rows) are limited to 32 only and therefore use only 5 reserved bits. In this embodiment, the number of bits ‘n’ available to use for this extension, thereby result in an ability to signal an ENUMERATED list of 2\hat{ }n entries.

Where the paging DCI includes an integer paging extension within the fourteen available bits described above, or when the fourteen bits are partitioned to signal multiple integers as paging extensions to multiple UE devices, the next question is how a UE that receives the paging DCI determines if the received PE (or one of the signaled PEs) is meant for it. Determining whether a PE is meant for a particular UE is easiest is if only one PE is signaled as an integer in the Paging DCI, and if that PE applies to all UEs that are confirmed by the network side to expect a PE using the handshake procedure described above. Since sending one PE to all the UEs that expect a PE in the paging DCI is quite restrictive, the fourteen available bits in the paging DCI may be partitioned to signal multiple integers as paging extensions to multiple UE devices in the paging DCI, as described before. In this case, the Paging message may indicate which of the integers is the paging extension for which of the UEs that are confirmed to expect a PE.

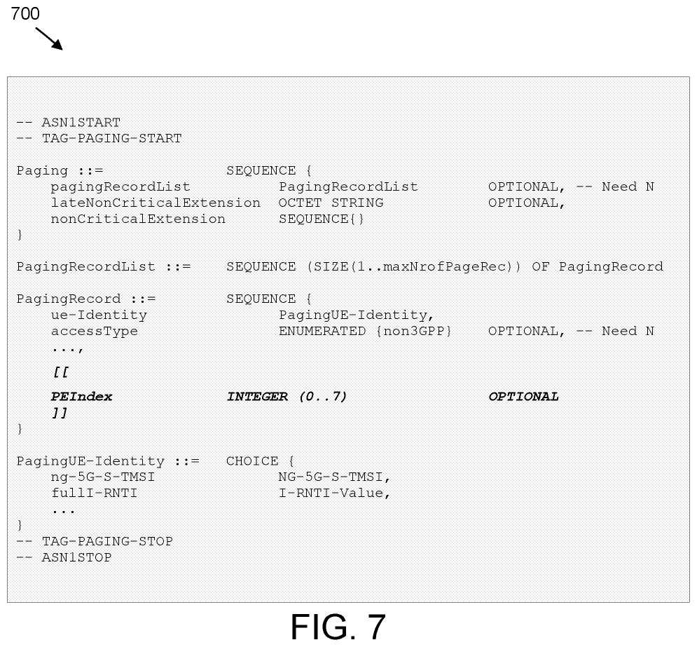

FIG. 7 depicts one embodiment of a format 700 for a paging message including an indicator of which UEs receive which paging extensions. As in FIGS. 3 and 4, bold plus italic typeface is used to show modifications to the legacy RRC paging message specification, to support PEs. In this case the added PEIndex information element explicitly indicates which PE integer in the paging DCI (in order of appearance) applies to which ue-Identity. The example in format 700 for a paging message illustrates a mechanism allowing the PagingRecord for a UE to indicate which of up to eight integers in the paging DCI applies as the paging extension for the UE identified in the paging record.

Alternatively, in some embodiments, a table such as the tables 500, 600 depicted in FIGS. 5 and 6 may be used to encode a PE as an integer, and that integer may be included directly in the paging message rather than in the paging DCI. Such an embodiment would be similar to the first solution by including the PE in the paging message rather than in the paging DCI, but would limit the amount of information added to the paging message.

According to embodiments of a third solution, providing a paging extension includes providing the paging extension in a PDSCH transmission separate from a legacy PDSCH transmission used for paging UE devices without paging extensions. In the first and second solutions described above, the PE was an extension to legacy paging messages (first solution) or legacy paging DCI (second solution). In the third solution, the paging DCI and the PDSCH transmission with the PE are separate from a legacy paging DCI and a legacy PDSCH transmission used for paging UE devices without paging extensions

Thus, in some embodiments, a PE is signaled not directly in the Paging DCI or in current RRC Paging message defined in Rel-16 but by using an associated PDSCH message. The associated PDSCH message may be transmitted in a separate time-frequency radio resource from the time-frequency radio resource used for the legacy Paging message. This can be done in a variety of possible ways.

In a first implementation, the paging DCI includes the binary value “00” in a Short Message Indicator field. As described above for DCI format 1_0, the bit field for the Short Message Indicator has binary value “01” if only scheduling information for paging is present in the DCI, binary value “10” if only a short message is present in the DCI, and binary value “11” if both scheduling information for paging and a short message are present in the DCI. However, the binary value “00” is reserved. Thus, reusing DCI format 1_0 for the (non-legacy) paging DCI, while using the reserved bit field ‘00’ in the Short Message Indicator field, distinguishes this paging DCI from a legacy paging DCI.

UEs not expecting PE or not capable of PE will ignore the non-legacy DCI upon receiving reserved bit field ‘00’ in the Short Message indicator field and will not try to receive the PDSCH transmission that the non-legacy paging DCI schedules. Therefore, using this DCI format will indicate that the frequency and/or time domain resource assignment specified in the DCI are not for the legacy RRC Paging message but for an associated PDSCH transmission, and UEs expecting a PE will go further and receive the non-legacy PDSCH transmission using the rest of the fields in DCI format 1_0.

In one variant, the non-legacy PDSCH may contain both the PE(s) and corresponding ue-Identity(s) so that a UE knows whether the PE is for it or not. The scheduling assignment in this embodiment therefore allows for a signaling of time-frequency allocation for the paging message on the non-legacy PDSCH, distinct from the legacy message. The reserved bit field is used as a pivot to assign time-frequency allocations for the PEs. The legacy paging is still received in the legacy way (i.e., when the reserved bit field is not set to ‘00’ in Short Message indicator).

In another variant, the non-legacy PDSCH may contain PE(s) as well as legacy RRC Paging contents including corresponding ue-Identity(s) so that a UE knows whether the paging and PE is for it or not. The scheduling assignment in this embodiment therefore allows for a signaling of time-frequency allocation for the paging message on the PDSCH distinct from the legacy message. The reserved bit field is used as a pivot to assign larger time-frequency allocations for the paging message.

According to another implementation, the non-legacy paging DCI for scheduling the non-legacy PDSCH transmission is sent and received in a in a monitoring occasion separate from a set of monitoring occasions defined for receiving legacy paging DCIs. For example, legacy UEs may be configured to monitor for paging DCIs at a distinct set of paging occurrences (“POs”) (e.g., once per DRX cycle), and the non-legacy UEs may monitor for non-legacy paging DCIs at different paging occurrences (e.g., still once per DRX cycle, but at a time offset from the POs for legacy DCIs).

In this implementation, non-legacy paging DCI format 1_0 with the reserved bit field ‘00’ in Short Message indicator” is not transmitted in the “regular” paging occurrence (“PO”) monitoring occasions (i.e., paging frame (“PF”)+PO as defined in 3GPP TS 38.304) but in different PO monitoring occasions (i.e., one or more of different Paging frames, Paging occasions and Physical Downlink Control Channel (“PDCCH”) monitoring occasions for receiving Paging). Various ways of ways of determining different PO monitoring occasions are disclosed in U.S. Provisional Patent Application No. 63/050,059 entitled “AVOIDANCE OF PAGING COLLISION IN MUSIM SCENARIO” and filed on Jul. 9, 2020, for Prateek Basu Mallick, Joachim Loehr, Ravi Kuchibhotla, and Hyung-Nam Choi, which application is incorporated herein by reference.

Optionally, the reserved bit field ‘00’ in Short Message indicator or any other reserved bit of the DCI format 1_0 may be used to confirm that the said DCI received in different PO monitoring occasions is indeed for signaling an associated PDSCH. The UEs expecting a PE will go further and receive the associated PDSCH using rest of the fields in DCI format 1_0.

In one variant, the non-legacy PDSCH may contain PE(s) and corresponding ue-Identity(s) so that a UE knows whether the PE is for it or not. The scheduling assignment in this embodiment therefore allows for a signaling of time-frequency allocation for the paging message on the PDSCH distinct from the legacy message. The different PO monitoring occasions are used as a pivot to assign time-frequency allocations for the PEs. The legacy paging is still received in the legacy way (i.e., on the “regular” paging occasions and the reserved bit field is not set to ‘00’ in Short Message indicator).

In another variant, the non-legacy PDSCH may contain PE(s) as well as legacy RRC Paging contents including corresponding ue-Identity(s) so that a UE knows whether the paging and PE is for it or not. The scheduling assignment in this embodiment therefore allows for a signaling of time-frequency allocation for the paging message on the PDSCH distinct from the legacy message. The different PO monitoring occasions are used as a pivot to assign larger time-frequency allocations for the paging message.

According to another implementation, a new DCI format is used to schedule the non-legacy PDSCH transmission. In one variant, a new DCI format with CRC scrambled by P-RNTI is used but transmitted in different PO monitoring occasions from the legacy paging DCI, as described previously. In another variant, a new DCI format with CRC scrambled by a new-P-RNTI is used which can either be transmitted in “regular” PO monitoring occasions (from TS 38.304) or in different PO monitoring occasions as described previously.

For example, the legacy paging DCI may include a legacy DCI format with a CRC scrambled by a legacy P-RNTI (e.g., hex value 0xFFFE for Rel-16). Thus, a new DCI format for a paging DCI may differ from the legacy paging DCI format in a variety of ways such as by having CRC scrambled with a non-legacy P-RNTI that differs from the legacy P-RNTI. Thus, legacy UEs using the legacy P-RNTI will not unscramble the new paging DCI or receive the associated non-legacy PDSCH transmission.

Various other or further alterations may be made to a legacy DCI format to provide a new DCI format. The new DCI format with CRC scrambled by the legacy P-RNTI or with CRC scrambled by a new, non-legacy P-RNTI signals time-frequency resources for an associated non-legacy PDSCH.

In one variant, the non-legacy PDSCH may contain PE(s) and corresponding ue-Identity(s) so that a UE knows whether the PE is for it or not. The scheduling assignment in this embodiment therefore allows for a signaling of time-frequency allocation for the paging message on the PDSCH distinct from the legacy message. The new DCI format is used as a pivot to assign time-frequency allocations for the PEs. The legacy paging is still received in the legacy way (i.e., using legacy DCI format).

In another variant, the non-legacy PDSCH may contain PE(s) as well as legacy RRC Paging contents including corresponding ue-Identity(s) so that a UE knows whether the paging and PE is for it or not. The scheduling assignment in this embodiment therefore allows for a signaling of time-frequency allocation for the paging message on the PDSCH distinct from the legacy message. The new DCI format is used as a pivot to assign larger time-frequency allocations for the paging message.

Various enhancements of the previously described solutions, implementations, and variants may be used to further facilitate paging extensions. As a useful enhancement to the embodiments described previously, the paging DCI format 1_0 with CRC scrambled by P-RNTI may contain an indicator indicating that one or more PEs are being transmitted. The actual transmission of PE can be made using any of the means described so far and known to the UE already by virtue of 3GPP specification. Since DCI format 1_0 has size limitations, the RRC paging message may use a Boolean flag to indicate if there will be a PE sent to a particular UE.

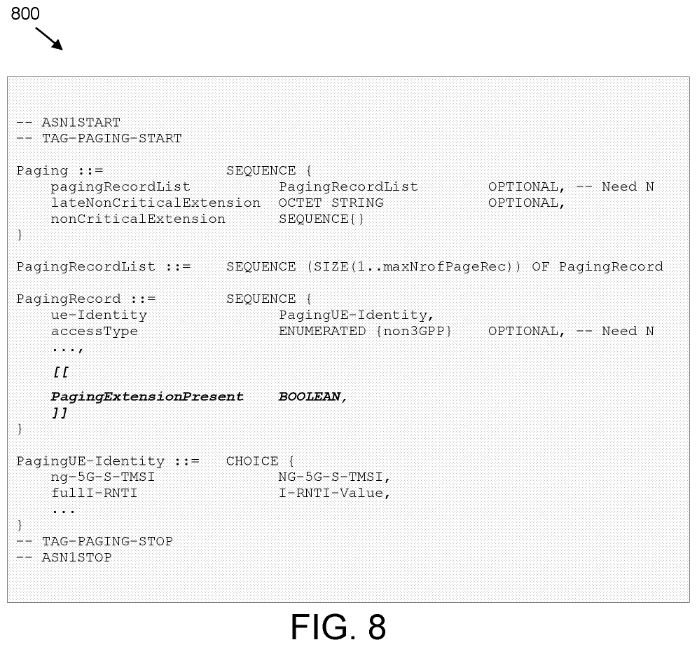

FIG. 8 depicts one embodiment of a format 800 for a paging message including a Boolean flag to notify a UE to monitor for paging extensions. As in FIGS. 3, 4 and 7, bold plus italic typeface is used to show modifications to the legacy RRC paging message specification, to support PEs. In this case the added PagingExtensionPresent information element is a Boolean flag to notify a UE to monitor for paging extensions. While a UE may be confirmed (e.g., by a handshake procedure) to expect a PE, the use of such a flag in the paging message itself may indicate that such PEs are actually present.

The Boolean indicator in the PagingRecord will alert the UE indicated in the PagingRecord to monitor for a new DCI format, monitor using a new-P-RNTI, and/or monitor on different PO monitoring occasions, or the like to receive a non-legacy paging DCI providing scheduling information for the Paging Extension. A UE targeted to receive a Paging extension will thus monitor and decode a second DCI format when the Boolean flag PagingExtensionPresent is set. Conversely, when the Boolean flag in the PagingRecord for a UE is set to False, the UE may simply follow legacy procedure to receive a legacy paging message.

Another way to notify a UE to monitor for paging extensions would be to add a new IE to the legacy paging message format using nonCriticalExtension and then include all ue-Identity (identities) using a 32 (maxNrofPageRec) bit-BITMAP to indicate which UEs should expect a PE. Since this is to be added using a nonCriticalExtension, it will be interpreted by the new UEs expecting a PE, and not by legacy UEs.

Although different embodiments and their implementations may work standalone to extend the Paging content, combinations of one or more of implementations from the solutions described herein is also possible. For example, it may be useful to extend the RRC Paging message, as in the first solution, with the second solution to also include some extensions in the paging DCI, to share the load of extension or to alert the UE to what it should expect to receive in the RRC Paging message. Similar combinations of other embodiments and implementations are also possible.

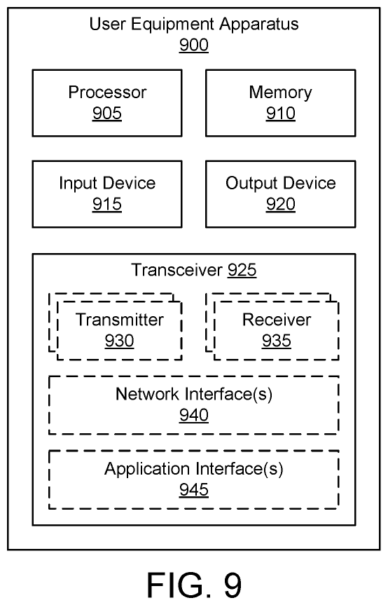

FIG. 9 depicts a user equipment apparatus 900 that may be used for extended paging messages, according to embodiments of the disclosure. In various embodiments, the user equipment apparatus 900 is used to implement one or more of the solutions described above. The user equipment apparatus 900 may be one embodiment of the remote unit 105 and/or the UE 205, described above. Furthermore, the user equipment apparatus 900 may include a processor 905, a memory 910, an input device 915, an output device 920, and a transceiver 925.

In some embodiments, the input device 915 and the output device 920 are combined into a single device, such as a touchscreen. In certain embodiments, the user equipment apparatus 900 may not include any input device 915 and/or output device 920. In various embodiments, the user equipment apparatus 900 may include one or more of: the processor 905, the memory 910, and the transceiver 925, and may not include the input device 915 and/or the output device 920.

As depicted, the transceiver 925 includes at least one transmitter 930 and at least one receiver 935. In some embodiments, the transceiver 925 communicates with one or more cells (or wireless coverage areas) supported by one or more base units 121. In various embodiments, the transceiver 925 is operable on unlicensed spectrum. Moreover, the transceiver 925 may include multiple UE panels supporting one or more beams. Additionally, the transceiver 925 may support at least one network interface 940 and/or application interface 945. The application interface(s) 945 may support one or more APIs. The network interface(s) 940 may support 3GPP reference points, such as Uu, N1, PC5, etc. Other network interfaces 940 may be supported, as understood by one of ordinary skill in the art.

The processor 905, in one embodiment, may include any known controller capable of executing computer-readable instructions and/or capable of performing logical operations. For example, the processor 905 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 905 executes instructions stored in the memory 910 to perform the methods and routines described herein. The processor 905 is communicatively coupled to the memory 910, the input device 915, the output device 920, and the transceiver 925.

In various embodiments, the processor 905 controls the user equipment apparatus 900 to implement the above described UE behaviors. In certain embodiments, the processor 905 may include an application processor (also known as “main processor”) which manages application-domain and operating system (“OS”) functions and a baseband processor (also known as “baseband radio processor”) which manages radio functions.

In various embodiments, via the transceiver 925, the processor 905 sends a message to a network node, with the message indicating that the UE supports paging extensions. The transceiver 925 receives a confirmation message from the network node, with the confirmation message notifying the UE to expect paging extensions. The transceiver 925 receives a paging DCI with a CRC scrambled by a P-RNTI, where the paging DCI schedules a PDSCH transmission. The transceiver 925 receives a paging message in the PDSCH transmission. The processor 905 identifies a paging extension for the UE in the paging DCI and/or the paging message.

In some embodiments, the transceiver 925 sends the message indicating that the UE supports paging extensions in response to receiving a message indicating network support for paging extensions. In some embodiments, the paging message is an RRC paging message, and the paging extension is included in the RRC paging message.

In some embodiments, the paging extension is an integer included in the paging DCI, within fourteen bits assigned to an eight-bit Short Messages field and a six-bit Reserved Bits field. In further embodiments, the processor 905 references a table to convert the integer to at least one information element. In some embodiments, the fourteen bits are partitioned to signal multiple integers as paging extensions to multiple UE devices, and the paging message indicates which of the integers is the paging extension for the UE.

In some embodiments, the paging DCI and the PDSCH transmission are separate from a legacy paging DCI and a legacy PDSCH transmission used for paging UE devices without paging extensions. In some embodiments, the paging DCI includes the binary value “00” in a Short Message Indicator field. In some embodiments, the transceiver 925 receives the paging DCI in a monitoring occasion separate from a set of monitoring occasions defined for receiving legacy paging DCIs.

In some embodiments, the legacy paging DCI incudes a legacy DCI format with a CRC scrambled by a legacy P-RNTI. In further embodiments, the paging DCI includes a new format that differs from the legacy DCI format. In some embodiments, the P-RNTI differs from the legacy P-RNTI.

The memory 910, in one embodiment, is a computer readable storage medium. In some embodiments, the memory 910 includes volatile computer storage media. For example, the memory 910 may include a RAM, including dynamic RAM (“DRAM”), synchronous dynamic RAM (“SDRAM”), and/or static RAM (“SRAM”). In some embodiments, the memory 910 includes non-volatile computer storage media. For example, the memory 910 may include a hard disk drive, a flash memory, or any other suitable non-volatile computer storage device. In some embodiments, the memory 910 includes both volatile and non-volatile computer storage media.

In some embodiments, the memory 910 stores data related to extended paging messages. For example, the memory 910 may store a paging DCI, a paging message, a paging extension, a table for converting an integer paging extension to at least one information element, or the like. The memory 910 may store parameters, configurations, resource assignments, policies, and the like, as described above. In certain embodiments, the memory 910 also stores program code and related data, such as an operating system or other controller algorithms operating on the apparatus 900.

The input device 915, in one embodiment, may include any known computer input device including a touch panel, a button, a keyboard, a stylus, a microphone, or the like. In some embodiments, the input device 915 may be integrated with the output device 920, for example, as a touchscreen or similar touch-sensitive display. In some embodiments, the input device 915 includes a touchscreen such that text may be input using a virtual keyboard displayed on the touchscreen and/or by handwriting on the touchscreen. In some embodiments, the input device 915 includes two or more different devices, such as a keyboard and a touch panel.

The output device 920, in one embodiment, is designed to output visual, audible, and/or haptic signals. In some embodiments, the output device 920 includes an electronically controllable display or display device capable of outputting visual data to a user. For example, the output device 920 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 920 may include a wearable display separate from, but communicatively coupled to, the rest of the user equipment apparatus 900, such as a smart watch, smart glasses, a heads-up display, or the like. Further, the output device 920 may be a component of a smart phone, a personal digital assistant, a television, a table computer, a notebook (laptop) computer, a personal computer, a vehicle dashboard, or the like.

In certain embodiments, the output device 920 includes one or more speakers for producing sound. For example, the output device 920 may produce an audible alert or notification (e.g., a beep or chime). In some embodiments, the output device 920 includes one or more haptic devices for producing vibrations, motion, or other haptic feedback. In some embodiments, all or portions of the output device 920 may be integrated with the input device 915. For example, the input device 915 and output device 920 may form a touchscreen or similar touch-sensitive display. In other embodiments, the output device 920 may be located near the input device 915.

The transceiver 925 communicates with one or more network functions of a mobile communication network via one or more access networks. The transceiver 925 operates under the control of the processor 905 to transmit messages, data, and other signals and also to receive messages, data, and other signals. For example, the processor 905 may selectively activate the transceiver 925 (or portions thereof) at particular times in order to send and receive messages.

The transceiver 925 includes at least transmitter 930 and at least one receiver 935. One or more transmitters 930 may be used to provide UL communication signals to a base unit 121, such as the UL transmissions described herein. Similarly, one or more receivers 935 may be used to receive DL communication signals from the base unit 121, as described herein. Although only one transmitter 930 and one receiver 935 are illustrated, the user equipment apparatus 900 may have any suitable number of transmitters 930 and receivers 935. Further, the transmitter(s) 930 and the receiver(s) 935 may be any suitable type of transmitters and receivers. In one embodiment, the transceiver 925 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 925, transmitters 930, and receivers 935 may be implemented as physically separate components that access a shared hardware resource and/or software resource, such as for example, the network interface 940.

In various embodiments, one or more transmitters 930 and/or one or more receivers 935 may be implemented and/or integrated into a single hardware component, such as a multi-transceiver chip, a system-on-a-chip, an Application-Specific Integrated Circuit (“ASIC”), or other type of hardware component. In certain embodiments, one or more transmitters 930 and/or one or more receivers 935 may be implemented and/or integrated into a multi-chip module. In some embodiments, other components such as the network interface 940 or other hardware components/circuits may be integrated with any number of transmitters 930 and/or receivers 935 into a single chip. In such embodiment, the transmitters 930 and receivers 935 may be logically configured as a transceiver 925 that uses one more common control signals or as modular transmitters 930 and receivers 935 implemented in the same hardware chip or in a multi-chip module.

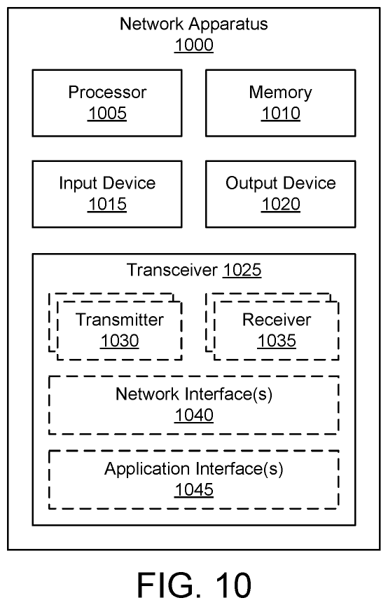

FIG. 10 depicts a network apparatus 1000 that may be used for performing extended paging messages, according to embodiments of the disclosure. In one embodiment, network apparatus 1000 may be one implementation of a RAN node, such as the base unit 121 and/or the RAN node 210, as described above. Furthermore, the base network apparatus 1000 may include a processor 1005, a memory 1010, an input device 1015, an output device 1020, and a transceiver 1025.

In some embodiments, the input device 1015 and the output device 1020 are combined into a single device, such as a touchscreen. In certain embodiments, the network apparatus 1000 may not include any input device 1015 and/or output device 1020. In various embodiments, the network apparatus 1000 may include one or more of: the processor 1005, the memory 1010, and the transceiver 1025, and may not include the input device 1015 and/or the output device 1020.

As depicted, the transceiver 1025 includes at least one transmitter 1030 and at least one receiver 1035. Here, the transceiver 1025 communicates with one or more remote units 105. Additionally, the transceiver 1025 may support at least one network interface 1040 and/or application interface 1045. The application interface(s) 1045 may support one or more APIs. The network interface(s) 1040 may support 3GPP reference points, such as Uu, N1, N2 and N3. Other network interfaces 1040 may be supported, as understood by one of ordinary skill in the art.

The processor 1005, in one embodiment, may include any known controller capable of executing computer-readable instructions and/or capable of performing logical operations. For example, the processor 1005 may be a microcontroller, a microprocessor, a CPU, a GPU, an auxiliary processing unit, a FPGA, or similar programmable controller. In some embodiments, the processor 1005 executes instructions stored in the memory 1010 to perform the methods and routines described herein. The processor 1005 is communicatively coupled to the memory 1010, the input device 1015, the output device 1020, and the transceiver 1025.

In various embodiments, the network apparatus 1000 is a RAN node (e.g., gNB) that communicates with one or more UEs, as described herein. In such embodiments, the processor 1005 controls the network apparatus 1000 to perform the above described RAN behaviors. When operating as a RAN node, the processor 1005 may include an application processor (also known as “main processor”) which manages application-domain and operating system (“OS”) functions and a baseband processor (also known as “baseband radio processor”) which manages radio functions.

In various embodiments, the transceiver 1025 receives a message from a UE device, with the message indicating that the UE device supports paging extensions. The transceiver 1025 sends a confirmation message to the UE device, the confirmation message notifying the UE device to expect paging extensions. The transceiver 1025 sends a paging DCI with a CRC scrambled by a P-RNTI, the paging DCI scheduling a PDSCH transmission. The transceiver 1025 sends a paging message in the PDSCH transmission. The processor 1005 includes a paging extension for the UE device in the paging DCI and/or the paging message.

In some embodiments, the transceiver 1025 receiving the message indicating that the UE device supports paging extensions is in response to the transceiver 1025 sending a message indicating network support for paging extensions. In some embodiments, the paging message is an RRC paging message, and the paging extension is included in the RRC paging message.

In some embodiments, the paging extension is an integer included in the paging DCI, within fourteen bits assigned to an eight-bit Short Messages field and a six-bit Reserved Bits field. In some embodiments, the processor 1005 determines the integer based on a table that maps integers to information elements. In some embodiments, the fourteen bits are partitioned to signal multiple integers as paging extensions to multiple UE devices, and the paging message indicates which of the integers is the paging extension for the UE device.

In some embodiments, the paging DCI and the PDSCH transmission are separate from a legacy paging DCI and a legacy PDSCH transmission used for paging UE devices without paging extensions. In some embodiments, the paging DCI includes the binary value “00” in a Short Message Indicator field. In some embodiments, the transceiver 1025 sends the paging DCI in a monitoring occasion separate from a set of monitoring occasions defined for sending legacy paging DCIs.

In some embodiments, the legacy paging DCI comprises a legacy DCI format with a CRC scrambled by a legacy P-RNTI. In some embodiments, the paging DCI comprises a new format that differs from the legacy DCI format. In some embodiments, the P-RNTI differs from the legacy P-RNTI.

The memory 1010, in one embodiment, is a computer readable storage medium. In some embodiments, the memory 1010 includes volatile computer storage media. For example, the memory 1010 may include a RAM, including dynamic RAM (“DRAM”), synchronous dynamic RAM (“SDRAM”), and/or static RAM (“SRAM”). In some embodiments, the memory 1010 includes non-volatile computer storage media. For example, the memory 1010 may include a hard disk drive, a flash memory, or any other suitable non-volatile computer storage device. In some embodiments, the memory 1010 includes both volatile and non-volatile computer storage media.

In some embodiments, the memory 1010 stores data related to extended paging messages. For example, the memory 1010 may store a paging DCI, a paging message, a paging extension, a table for converting at least one information element to an integer paging extension, or the like. The memory 1010 may store parameters, configurations, resource assignments, policies, and the like, as described above. In certain embodiments, the memory 1010 also stores program code and related data, such as an operating system or other controller algorithms operating on the apparatus 1000.

The input device 1015, in one embodiment, may include any known computer input device including a touch panel, a button, a keyboard, a stylus, a microphone, or the like. In some embodiments, the input device 1015 may be integrated with the output device 1020, for example, as a touchscreen or similar touch-sensitive display. In some embodiments, the input device 1015 includes a touchscreen such that text may be input using a virtual keyboard displayed on the touchscreen and/or by handwriting on the touchscreen. In some embodiments, the input device 1015 includes two or more different devices, such as a keyboard and a touch panel.

The output device 1020, in one embodiment, is designed to output visual, audible, and/or haptic signals. In some embodiments, the output device 1020 includes an electronically controllable display or display device capable of outputting visual data to a user. For example, the output device 1020 may include, but is not limited to, an LCD display, an LED display, an OLED display, a projector, or similar display device capable of outputting images, text, or the like to a user. As another, non-limiting, example, the output device 1020 may include a wearable display separate from, but communicatively coupled to, the rest of the network apparatus 1000, such as a smart watch, smart glasses, a heads-up display, or the like. Further, the output device 1020 may be a component of a smart phone, a personal digital assistant, a television, a table computer, a notebook (laptop) computer, a personal computer, a vehicle dashboard, or the like.

In certain embodiments, the output device 1020 includes one or more speakers for producing sound. For example, the output device 1020 may produce an audible alert or notification (e.g., a beep or chime). In some embodiments, the output device 1020 includes one or more haptic devices for producing vibrations, motion, or other haptic feedback. In some embodiments, all or portions of the output device 1020 may be integrated with the input device 1015. For example, the input device 1015 and output device 1020 may form a touchscreen or similar touch-sensitive display. In other embodiments, the output device 1020 may be located near the input device 1015.

The transceiver 1025 includes at least transmitter 1030 and at least one receiver 1035. One or more transmitters 1030 may be used to communicate with the UE, as described herein. Similarly, one or more receivers 1035 may be used to communicate with network functions in the PLMN and/or RAN, as described herein. Although only one transmitter 1030 and one receiver 1035 are illustrated, the network apparatus 1000 may have any suitable number of transmitters 1030 and receivers 1035. Further, the transmitter(s) 1030 and the receiver(s) 1035 may be any suitable type of transmitters and receivers.

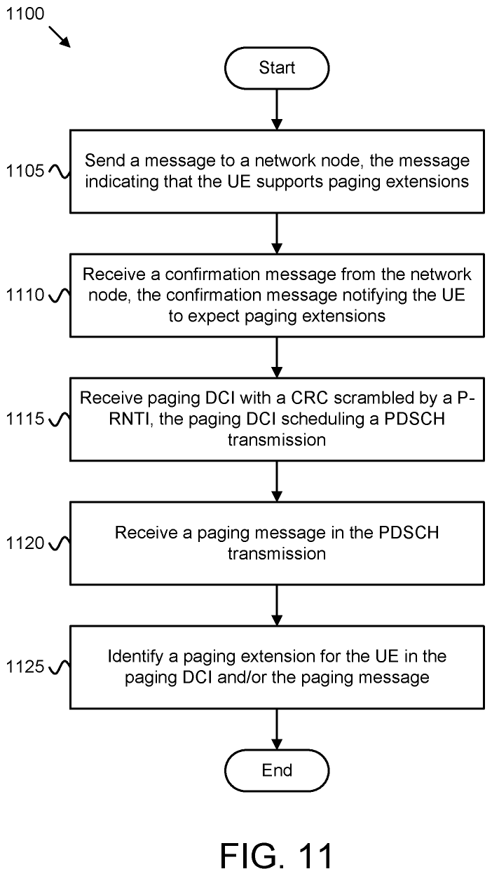

FIG. 11 depicts one embodiment of a method 1100 for extended paging messages, according to embodiments of the disclosure. In various embodiments, the method 1100 is performed by a user equipment device in a mobile communication network, such as the remote unit 105, the UE 205, and/or the user equipment apparatus 900, described above. In some embodiments, the method 1100 is performed by a processor, such as a microcontroller, a microprocessor, a CPU, a GPU, an auxiliary processing unit, a FPGA, or the like.

The method 1100 begins and sends 1105 a message to a network node, the message indicating that the UE device supports paging extensions. The method 1100 includes receiving 1110 a confirmation message from the network node, the confirmation message notifying the UE device to expect paging extensions. The method 1100 includes receiving 1115 a paging DCI with a CRC scrambled by a P-RNTI, the paging DCI scheduling a PDSCH transmission. The method includes receiving 1120 a paging message in the PDSCH transmission. The method 1100 includes identifying 1125 a paging extension for the UE device in the paging DCI and/or the paging message. The method 1100 ends.

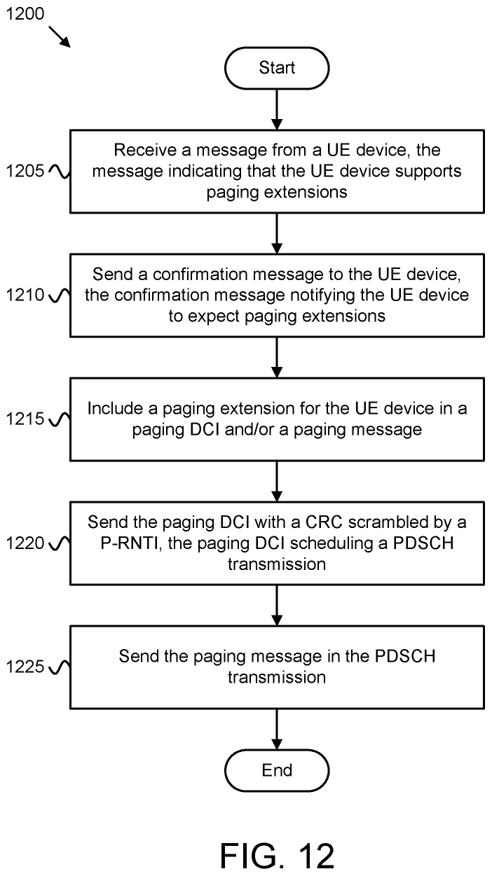

FIG. 12 depicts one embodiment of a method 1200 for extended paging messages, according to embodiments of the disclosure. In various embodiments, the method 1200 is performed by a network entity or node in a mobile communication network, such as the AMF 143, the base unit 121, the RAN node 210, the AMF 215, and/or the network apparatus 1000, described above. In some embodiments, the method 1200 is performed by a processor, such as a microcontroller, a microprocessor, a CPU, a GPU, an auxiliary processing unit, a FPGA, or the like.

The method 1200 begins and receives 1205 a message from a UE device, with the message indicating that the UE device supports paging extensions. The method 1200 includes sending 1210 a confirmation message to the UE device, the confirmation message notifying the UE device to expect paging extensions. The method 1200 includes including 1215 a paging extension for the UE device in a paging DCI and/or a paging message. The method 1200 includes sending 1220 a paging DCI with a CRC scrambled by a P-RNTI, the paging DCI scheduling a PDSCH transmission. The method 1200 includes sending 1225 a paging message in the PDSCH transmission. The method 1200 ends.

Disclosed herein is a first apparatus for extended paging messages, according to embodiments of the disclosure. The first apparatus may be implemented by a user equipment device in a mobile communication network, such as the remote unit 105, the UE 205, and/or the user equipment apparatus 900, described above. The first apparatus includes a processor, and a transceiver that sends a message to a network node, with the message indicating that the UE supports paging extensions. The transceiver receives a confirmation message from the network node, with the confirmation message notifying the UE to expect paging extensions. The transceiver receives a paging DCI with a CRC scrambled by a P-RNTI, where the paging DCI schedules a PDSCH transmission. The transceiver receives a paging message in the PDSCH transmission. The processor identifies a paging extension for the UE in the paging DCI and/or the paging message.

In some embodiments, the transceiver sends the message indicating that the UE supports paging extensions in response to receiving a message indicating network support for paging extensions. In some embodiments, the paging message is an RRC paging message, and the paging extension is included in the RRC paging message.

In some embodiments, the paging extension is an integer included in the paging DCI, within fourteen bits assigned to an eight-bit Short Messages field and a six-bit Reserved Bits field. In further embodiments, the processor references a table to convert the integer to at least one information element. In some embodiments, the fourteen bits are partitioned to signal multiple integers as paging extensions to multiple UE devices, and the paging message indicates which of the integers is the paging extension for the UE.

In some embodiments, the paging DCI and the PDSCH transmission are separate from a legacy paging DCI and a legacy PDSCH transmission used for paging UE devices without paging extensions. In some embodiments, the paging DCI includes the binary value “00” in a Short Message Indicator field. In some embodiments, the transceiver receives the paging DCI in a monitoring occasion separate from a set of monitoring occasions defined for receiving legacy paging DCIs.

In some embodiments, the legacy paging DCI incudes a legacy DCI format with a CRC scrambled by a legacy P-RNTI. In further embodiments, the paging DCI includes a new format that differs from the legacy DCI format. In some embodiments, the P-RNTI differs from the legacy P-RNTI.

Disclosed herein is a first method for extended paging messages, according to embodiments of the disclosure. The first method may be performed by a user equipment device in a mobile communication network, such as the remote unit 105, the UE 205, and/or the user equipment apparatus 900, described above. The first method includes sending a message to a network node, the message indicating that the UE device supports paging extensions. The first method includes receiving a confirmation message from the network node, the confirmation message notifying the UE device to expect paging extensions. The first method includes receiving a paging DCI with a CRC scrambled by a P-RNTI, the paging DCI scheduling a PDSCH transmission. The method includes receiving a paging message in the PDSCH transmission. The first method includes identifying a paging extension for the UE device in the paging DCI and/or the paging message.

In some embodiments, the sending the message indicating that the UE supports paging extensions is in response to receiving a message indicating network support for paging extensions. In some embodiments, the paging message is an RRC paging message, and the paging extension is included in the RRC paging message.

In some embodiments, the paging extension is an integer included in the paging DCI, within fourteen bits assigned to an eight-bit Short Messages field and a six-bit Reserved Bits field. In further embodiments, the first method includes referencing a table to convert the integer to at least one information element. In some embodiments, the fourteen bits are partitioned to signal multiple integers as paging extensions to multiple UE devices, and the paging message indicates which of the integers is the paging extension for the UE.

In some embodiments, the paging DCI and the PDSCH transmission are separate from a legacy paging DCI and a legacy PDSCH transmission used for paging UE devices without paging extensions. In some embodiments, the paging DCI includes the binary value “00” in a Short Message Indicator field. In some embodiments, the paging DCI is received in a monitoring occasion separate from a set of monitoring occasions defined for receiving legacy paging DCIs.

In some embodiments, the legacy paging DCI incudes a legacy DCI format with a CRC scrambled by a legacy P-RNTI. In further embodiments, the paging DCI includes a new format that differs from the legacy DCI format. In some embodiments, the P-RNTI differs from the legacy P-RNTI.

Disclosed herein is a second apparatus for extended paging messages, according to embodiments of the disclosure. The second apparatus may be implemented by a network entity or node in a mobile communication network, such as the AMF 143, the base unit 121, the RAN node 210, AMF 215, and/or the network apparatus 1000, described above. The second apparatus includes a processor, and a transceiver that receives a message from a UE device, with the message indicating that the UE device supports paging extensions. The transceiver sends a confirmation message to the UE device, the confirmation message notifying the UE device to expect paging extensions. The transceiver sends a paging DCI with a CRC scrambled by a P-RNTI, the paging DCI scheduling a PDSCH transmission. The transceiver sends a paging message in the PDSCH transmission. The processor includes a paging extension for the UE device in the paging DCI and/or the paging message.

In some embodiments, the transceiver receiving the message indicating that the UE device supports paging extensions is in response to the transceiver sending a message indicating network support for paging extensions. In some embodiments, the paging message is an RRC paging message, and the paging extension is included in the RRC paging message.

In some embodiments, the paging extension is an integer included in the paging DCI, within fourteen bits assigned to an eight-bit Short Messages field and a six-bit Reserved Bits field. In some embodiments, the processor determines the integer based on a table that maps integers to information elements. In some embodiments, the fourteen bits are partitioned to signal multiple integers as paging extensions to multiple UE devices, and the paging message indicates which of the integers is the paging extension for the UE device.

In some embodiments, the paging DCI and the PDSCH transmission are separate from a legacy paging DCI and a legacy PDSCH transmission used for paging UE devices without paging extensions. In some embodiments, the paging DCI includes the binary value “00” in a Short Message Indicator field. In some embodiments, the transceiver sends the paging DCI in a monitoring occasion separate from a set of monitoring occasions defined for sending legacy paging DCIs.

In some embodiments, the legacy paging DCI comprises a legacy DCI format with a CRC scrambled by a legacy P-RNTI. In some embodiments, the paging DCI comprises a new format that differs from the legacy DCI format. In some embodiments, the P-RNTI differs from the legacy P-RNTI.

Disclosed herein is a second method for extended paging messages, according to embodiments of the disclosure. The second method may be performed by a network entity or node in a mobile communication network, such as the AMF 143, the base unit 121, the RAN node 210, the AMF 215 and/or the network apparatus 1000, described above. The second method includes receiving a message from a UE device, with the message indicating that the UE device supports paging extensions. The second method includes sending a confirmation message to the UE device, the confirmation message notifying the UE device to expect paging extensions. The second method includes sending a paging DCI with a CRC scrambled by a P-RNTI, the paging DCI scheduling a PDSCH transmission. The second method includes sending a paging message in the PDSCH transmission. The second method includes including a paging extension for the UE device in the paging DCI and/or the paging message.

In some embodiments, receiving the message indicating that the UE device supports paging extensions is in response to the network node sending a message indicating network support for paging extensions. In some embodiments, the paging message is an RRC paging message, and the paging extension is included in the RRC paging message.

In some embodiments, the paging extension is an integer included in the paging DCI, within fourteen bits assigned to an eight-bit Short Messages field and a six-bit Reserved Bits field. In some embodiments, the second method includes determining the integer based on a table that maps integers to information elements. In some embodiments, the fourteen bits are partitioned to signal multiple integers as paging extensions to multiple UE devices, and the paging message indicates which of the integers is the paging extension for the UE device.

In some embodiments, the paging DCI and the PDSCH transmission are separate from a legacy paging DCI and a legacy PDSCH transmission used for paging UE devices without paging extensions. In some embodiments, the paging DCI includes the binary value “00” in a Short Message Indicator field. In some embodiments, the paging DCI is sent in a monitoring occasion separate from a set of monitoring occasions defined for sending legacy paging DCIs.

In some embodiments, the legacy paging DCI comprises a legacy DCI format with a CRC scrambled by a legacy P-RNTI. In some embodiments, the paging DCI comprises a new format that differs from the legacy DCI format. In some embodiments, the P-RNTI differs from the legacy P-RNTI.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1.-15. (canceled)

16. A User Equipment (“UE”) apparatus comprising:
a memory; and
a processor coupled to the memory, the processor configured to cause the apparatus to:
send a message to a network node, the message indicating that the apparatus supports paging extensions;
receive a confirmation message from the network node, the confirmation message notifying the apparatus to expect paging extensions;
receive paging Downlink Control Information (“DCI”) with a cyclic redundancy check (“CRC”) scrambled by a Paging Radio Network Temporary Identifier (“P-RNTI”), the paging DCI scheduling a Physical Downlink Shared Channel (“PDSCH”) transmission;
receive a paging message in the PDSCH transmission; and
identify a paging extension for the apparatus in at least one of the paging DCI and the paging message.

17. The apparatus of claim 16, wherein the processor is configured to cause the apparatus to receive a message indicating network support for paging extensions prior to sending the message indicating that the apparatus supports paging extensions.

18. The apparatus of claim 16, wherein the paging message is a Radio Resource Control (“RRC”) paging message, and the paging extension is included in the RRC paging message.

19. The apparatus of claim 16, wherein the paging extension is an integer included in the paging DCI, within fourteen bits assigned to an eight-bit Short Messages field and a six-bit Reserved Bits field.

20. The apparatus of claim 19, wherein the processor is configured to cause the apparatus to reference a table to convert the integer to at least one information element.

21. The apparatus of claim 19, wherein the fourteen bits are partitioned to signal multiple integers as paging extensions to multiple UE devices, and wherein the paging message indicates which of the integers is the paging extension for the apparatus.

22. The apparatus of claim 16, wherein the paging DCI and the PDSCH transmission are separate from a legacy paging DCI and a legacy PDSCH transmission used for paging UE devices without paging extensions.

23. The apparatus of claim 22, wherein the paging DCI includes the binary value “00” in a Short Message Indicator field.

24. The apparatus of claim 22, wherein the processor is configured to cause the apparatus to receive the paging DCI in a monitoring occasion separate from a set of monitoring occasions defined for receiving legacy paging DCIs.

25. The apparatus of claim 22, wherein:
the legacy paging DCI comprises a legacy DCI format with a CRC scrambled by a legacy P-RNTI;
the paging DCI comprises a new format that differs from the legacy DCI format; and
the P-RNTI differs from the legacy P-RNTI.

26. A method of a User Equipment (“UE”) device, the method comprising:
sending a message to a network node, the message indicating that the UE device supports paging extensions;
receiving a confirmation message from the network node, the confirmation message notifying the UE device to expect paging extensions;
receiving paging Downlink Control Information (“DCI”) with a cyclic redundancy check (“CRC”) scrambled by a Paging Radio Network Temporary Identifier (“P-RNTI”), the paging DCI scheduling a Physical Downlink Shared Channel (“PDSCH”) transmission;
receiving a paging message in the PDSCH transmission; and
identifying a paging extension for the UE device in at least one of the paging DCI and the paging message.

27. A network node apparatus comprising:
a memory; and
a processor coupled to the memory, the processor configured to cause the apparatus to:
receive a message from a first User Equipment (“UE”), the message indicating that the UE device supports paging extensions;
send a confirmation message to the first UE, the confirmation message notifying the UE device to expect paging extensions;
send paging Downlink Control Information (“DCI”) with a cyclic redundancy check (“CRC”) scrambled by a Paging Radio Network Temporary Identifier (“P-RNTI”), the paging DCI scheduling a Physical Downlink Shared Channel (“PDSCH”) transmission;
send a paging message in the PDSCH transmission; and
include a paging extension for the first UE in at least one of the paging DCI and the paging message.

28. The apparatus of claim 27, wherein the processor is configured to cause the apparatus to send a message indicating network support for paging extensions prior to receiving the message indicating that the first UE supports paging extensions.

29. The apparatus of claim 27, wherein the paging message is a Radio Resource Control (“RRC”) paging message, and the paging extension is included in the RRC paging message.

30. The apparatus of claim 27, wherein the paging extension is an integer included in the paging DCI, within fourteen bits assigned to an eight-bit Short Messages field and a six-bit Reserved Bits field.

31. The apparatus of claim 30, wherein the fourteen bits are partitioned to signal multiple integers as paging extensions to multiple UE devices, and wherein the paging message indicates which of the integers is the paging extension for the UE.

32. The apparatus of claim 27, wherein the paging DCI and the PDSCH transmission are separate from a legacy paging DCI and a legacy PDSCH transmission used for paging UE devices without paging extensions.

33. The apparatus of claim 32, wherein the paging DCI includes the binary value “00” in a Short Message Indicator field.

34. The apparatus of claim 32, wherein the processor is configured to cause the apparatus to transmit the paging DCI in a monitoring occasion separate from a set of monitoring occasions defined for receiving legacy paging DCIs.

35. The apparatus of claim 32, wherein:
the legacy paging DCI comprises a legacy DCI format with a CRC scrambled by a legacy P-RNTI;
the paging DCI comprises a new format that differs from the legacy DCI format; and
the P-RNTI differs from the legacy P-RNTI.
